(19) United States
(12) Patent Application Publication
(10) Pub. No.: US 2011/0202318 A1
(43) Pub. Date: Aug. 18, 2011

(54) INTERFERENCE DETERMINATION DEVICE, INTERFERENCE DETERMINATION METHOD, AND COMPUTER PROGRAM PRODUCT

(75) Inventors: Kouji Demizu, Kawasaki (JP); Masayuki Kidera, Kawasaki (JP); Naoyuki Nozaki, Kawasaki (JP)

(73) Assignee: FUJITSU LIMITED, Kawasaki-shi (JP)

(21) Appl. No.: 13/019,807

(22) Filed: Feb. 2, 2011

(30) Foreign Application Priority Data
Feb. 12, 2010 (JP) 2010-029532

(51) Int. Cl. G06F 17/50

(52) U.S. Cl. 703/1

(57) ABSTRACT

A dividing unit 12 divides each of a plurality of component parts each represented by a three-dimensional polygon model into surfaces forming a periphery of the component part. A surface information creation unit 13 creates information of a contour of each of the surfaces obtained by the division by the dividing unit 12 as information relating to the surface. A surface interference determination unit 14 determines presence/absence of an interference state by selecting two component parts having possibility of interference and comparing contours of surfaces obtained from the selected component parts. The surface interference determination unit 14 performs the determination by sequentially changing the combination of component parts, thereby enabling the three-dimensional interference determination while suppressing memory consumption.

### CROSS-REFERENCE TO RELATED APPLICATION

This application is based upon and claims the benefit of priority of the prior Japanese Patent Application No. 2010-029532, filed on Feb. 12, 2010, the entire contents of which are incorporated herein by reference.

### FIELD

The embodiments discussed herein are directed to an interference determination device, an interference determination method, and an interference determination program.

### BACKGROUND

Three-dimensional Computer Aided Design (CAD)/Computer Aided Manufacturing (CAM) and computer graphic systems have heretofore been used. Owing to these technologies, the opportunity of effectively using three-dimensional shape data is increasing in various situations such as simulation and test on assemblability. Among others, in an assembly formed of a plurality of models, a function of detecting interference between the models is a useful function for checking a designing mistake or input mistake.

Data used for expressing a shape in a three-dimensional shape viewer are a polygon mesh that is in many cases generated by approximation from free-form surface data. In the case of detecting an interference state by using the polygon mesh, long time has been required for determining each of combinations when there are a large amount of objects in a space. The long time is required since the number of combinations is increased when round-robin interference check is conducted for polygon mesh pairs forming each of models in order to determine whether arbitrary polygon meshes intersect with each other in a large scale assembly.

Accordingly, in the case of performing high-speed and correct interference determination, overlapping determination using bounding volumes of objects, which is a so-called intersection determination, has been performed before executing the polygon mesh intersection determination, and, after refining the targets by performing the intersection determination, the determination on polygon mesh pairs has been performed.

The bounding volume is a single simple volume and includes at least one more complicated object. By employing the idea of simpler volume, it is possible to shorten the time required for determining whether there is overlapping as compared to the case of using the complicated objects covered by the simpler volume.

As technologies using the bounding volume, a technology of using a spherical object, a technology of using Axis-Aligned Bounding Box (AABB), and a technology using Oriented Bounding Box (OBB) are known. Among these, the technology using OBB is highly possible to confirm separation of object without performing the intersection determination using polygon mesh, since OBB best reflects a shape of an object and has high intersection determination accuracy.
Patent Document 1: Japanese Laid-open Publication No. 2001-282877
Patent Document 2: Japanese Laid-open Publication No. 2003-271687
Non-Patent Document 1: “Real Time Collision Detection for Game Programming”, written by Christer Ericson, translated by Tatsuya Nakamura, published by Born Digital Inc. on Oct. 25, 2005.

However, in the conventional OBB use, a polygon shape is divided, and OBBs containing the divided polygons are tree-structured. Therefore, depending on complication of the model serving as the object, there has been a problem that memory consumption is increased to 2 to 10 times of that required for using polygon shape only.

Further, in recent years, for the purpose of further improving the processing speed, there has been proposed a technology of attaining the improvement in processing speed by creating three-dimensional OBB by dividing into the unit of surface after the first OBB division creation and reducing the total number of OBBs to be created by diminishing a shape difference between OBBs and a model. However, since the feature of requiring creation of OBBs to an end is not changed, the large memory consumption due to OBBs has not changed.

In the case of creating a three-dimensional OBB by division by the unit of surface, it has been necessary to perform checking using adjacent polygons since it is impossible to determine whether or not there is interference when another surface is in contact with a surface.

As described above, the conventional technologies have the problem of the large memory consumption in three-dimensional shape interference determination.

### SUMMARY

According to an aspect of an embodiment of the invention, an interference determination device includes a polygon data input unit that inputs information of a first component part and a second component part each represented by a third-dimensional polygon model, a dividing unit that divides the first component part into surfaces forming a periphery of the first component part and divides the second component part into surfaces forming a periphery of the second component part, a surface information creation unit that creates information at least of a contour of each of the surfaces obtained by the division by the dividing unit as information relating to the surface, and a surface interference determination unit that determines an interference state between the first component part and the second component part by comparing the contour of the surface obtained from the first component part with the contour of the surface obtained from the second component part.

According to another aspect of an embodiment of the invention, a method for determining interference includes inputting information of a first component part and a second component part each represented by a three-dimensional polygon model, dividing the first component part into surfaces forming a periphery of the first component part, dividing the second component part into surfaces forming a periphery of the second component part, creating information at least of a contour of each of the surfaces obtained by the division at the dividing as information relating to the surface, and determining an interference state between the first component part and the second component part by comparing the contour of the surface obtained from the first component part and the contour of the surface obtained from the second component part.

According to still another aspect of an embodiment of the invention, a computer-readable recording medium stores therein a computer program causing a computer to execute inputting information of a first component part and a second component part each represented by a three-dimensional polygon model, dividing the first component part into surfaces forming a periphery of the first component part, dividing the second component part into surfaces forming a periphery of the second component part, creating information at least of a contour of each of the surfaces obtained by the division at the dividing as information relating to the surface, and determining an interference state between the first component part and the second component part by comparing the contour of the surface obtained from the first component part and the contour of the surface obtained from the second component part.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram schematically illustrating an interference determination device according to first embodiment 1;

FIG. 2 is a block diagram schematically illustrating an interference determination device according to second embodiment;

FIG. 3 is a diagram illustrating three-dimensional bounding volumes;

FIG. 4 is a diagram illustrating interference determinations by the three-dimensional bounding volumes;

FIG. 5 is a diagram illustrating hierarchization of a bounding volume;

FIG. 6 is a diagram illustrating creation of OBBs for component parts;

FIG. 7 is a diagram illustrating specific examples of division;

FIG. 8 is a diagram illustrating generation of contour line and attribution;

FIG. 9 is a diagram illustrating specific examples of line data;

FIG. 10 is a diagram illustrating calculation of a contour surface angle;

FIG. 11 is a diagram illustrating creation of OBS;

FIG. 12 is a diagram illustrating interference check of OBS;

FIG. 13 is a diagram illustrating specific examples of data of OBS;

FIG. 14 is a diagram illustrating calculation of an intersection line of OBSs;

FIG. 15 is a diagram illustrating one specific example of OBS intersection line data;

FIG. 16 is a diagram illustrating one specific example of extraction of intersection points;

FIG. 17 is a diagram illustrating one example of coordinate data of a start point, an end point, and intersection points of an intersection line;

FIG. 18 is a diagram illustrating rearranged coordinate data of the start point, end point, and intersection points of the intersection line;

FIG. 19 is a diagram illustrating comparison result data illustrating whether gaps between the start point and the end point and the intersection point are inside a surface shape of a surface sA1;

FIG. 20 is a diagram illustrating extraction of a secondary target line segment;

FIG. 21 is a diagram illustrating determination by an angle determination unit 43;

FIG. 22 is a diagram illustrating data examples of surfaces and specific examples of surface angles used by the angle determination unit 43;

FIG. 23 is a diagram illustrating one specific example of comparison by the angle determination unit 43;

FIG. 24 is a diagram illustrating determination by a target determination unit 44;

FIG. 25 is a flowchart illustrating creation of OBSs;

FIG. 26 is a flowchart illustrating an interference determination processing;

FIG. 27 is a flowchart illustrating the interference determination processing on the surface illustrated in FIG. 26; and

FIG. 28 is a flowchart illustrating the interference determination processing based on the secondary target line segment illustrated in FIG. 27.

### DESCRIPTION OF EMBODIMENTS

Preferred embodiments of the present invention will be explained with reference to accompanying drawings. The embodiments do not limit the disclosed technology.

### [a] First Embodiment

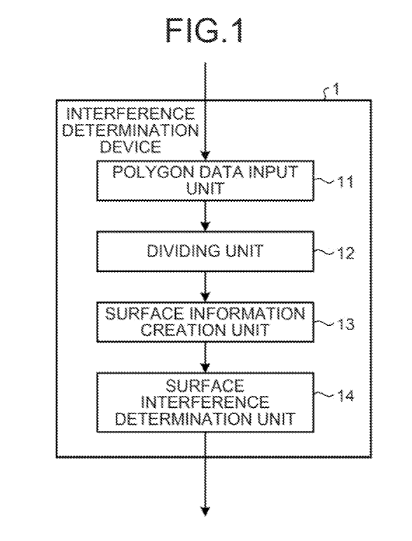

FIG. 1 is a block diagram schematically illustrating an interference determination device according to first embodiment. As illustrated in FIG. 1, an interference determination device 1 has a polygon data input unit 11, a dividing unit 12, a surface information creation unit 13, and a surface interference determination unit 14.

The polygon data input unit 11 is used for inputting information of a plurality of component parts represented by three-dimensional polygon models. The component part is referred to as a model or an object. The dividing unit 12 divides each of the component parts into surfaces forming a periphery of the component part. The surface information creation unit 13 creates information of a contour of each of the surfaces obtained by the division by the dividing unit 12 as information relating the surfaces.

The surface interference determination unit 14 selects two component parts that have possibility of interference to compare the contours of the surfaces obtained from the component parts and determines presence/absence of an interference state. The surface interference determination unit 14 performs the determination by sequentially changing combination of the component parts, thereby making it possible to determine the presence/absence of interference of each of the component parts inputted from the polygon data input unit 11.

As described above, the interference determination device of first embodiment divides each of the component parts each represented by the three-dimensional polygon into surfaces and performs the determination by using the contours of the surfaces, thereby making it possible to perform the interference determination of a three-dimensional shape while suppressing memory consumption.

### [b] Second Embodiment

### Device Configuration

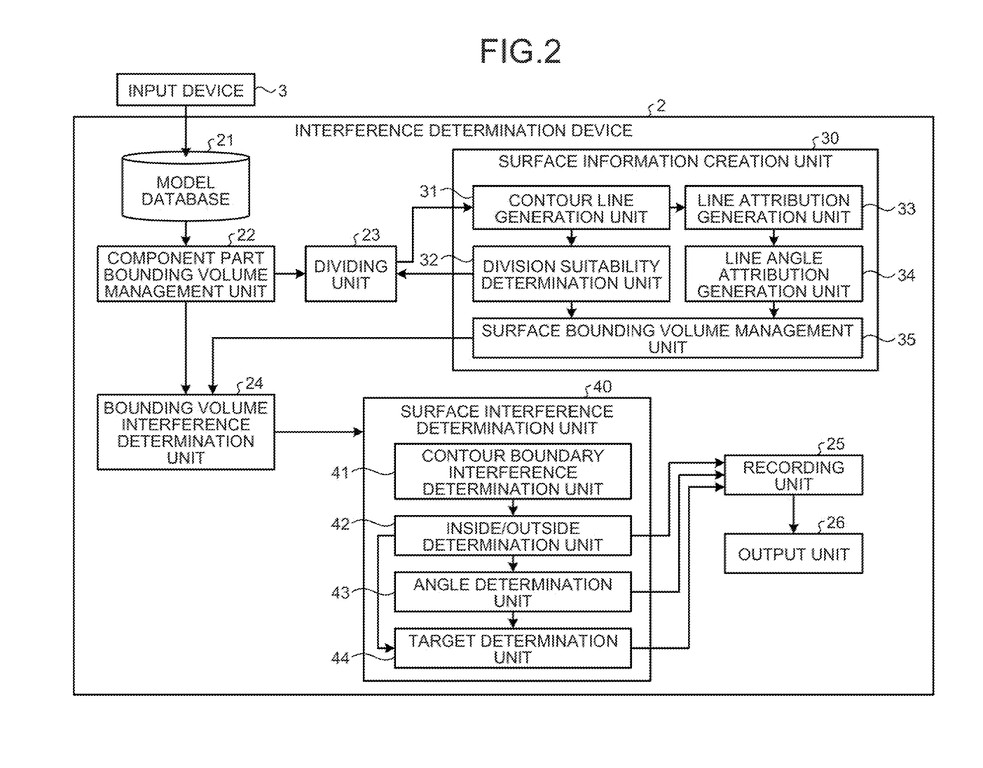

FIG. 2 is a block diagram schematically illustrating an interference determination device according to second embodiment. An interference determination device 2 internally has a model database 21, a component part bounding volume management unit 22, a dividing unit 23, a bounding volume interference determination unit 24, a recording unit 25, an output unit 26, a surface information creation unit 30, and a surface interference determination unit 40.

The model database 21 receives input of information of a plurality of component parts each represented by a three-dimensional polygon model and retains the information. The component part bounding volume management unit 22 creates a three-dimensional bounding volume for each of the component parts retained by the model database 21. The bounding volume interference determination unit 24 associates the created bounding volumes to the original component part information and outputs to the bounding volume interference determination unit 24 and the dividing unit 23.

The dividing unit 23 divides each of the component parts into surfaces forming a periphery of the component part and outputs the surfaces to the surface information creation unit 30. More specifically, the dividing unit 23 outputs a plurality of polygons of which normal lines are in an identical direction as one surface.

The surface information creation unit 30 has a contour line generation unit 31, a division suitability determination unit 32, a line attribution generation unit 33, a line angle attribution generation unit 34, and a surface bounding volume management unit 35.

The contour line generation unit 31 creates information of a contour of each of the surfaces obtained by the division by the dividing unit 23 as information relating to the surface. The division suitability determination unit 32 instructs the dividing unit 23 to divide the surface obtained by the division into a plurality of surfaces in the case where the number of contour lines of the surface is larger than a predetermined number. When the number of ultimately obtained contour lines is within the predetermined number, the division suitability determination unit 32 outputs the information of the contour lines to the surface bounding volume management unit 35.

The line attribution generation unit 33 generates line attribution for identifying whether the contour of the surface generated by the contour line generation unit 31 is an outer rim (outer line) or an inner rim (inner line) of the surface. The line angle attribution generation unit 34 creates line angle attribution of each of the contours indicating an angle formed with another one of surfaces of the identical component part sharing the contour.

The surface bounding volume management unit 35 manages the surface, contour line, line attribution, and line angle attribution after associating them to the information of the original component part. Further, the surface bounding volume management unit 35 creates a surface-like bounding volume enclosing the surface and manages the created surface-like bounding volume after associating with the surface bounding volume to the original component part.

The bounding volume interference determination unit 24 determines possibility of interference between component parts by using the three-dimensional bounding volumes output by the component part bounding volume management unit 22 and outputs a combination of component parts that has the possibility of interference and information of the component parts of the combination to the surface interference determination unit 40.

The surface interference determination unit 40 determines presence/absence of interference between the component parts based on the various information managed by the surface bounding volume management unit 35 and outputs information of the interfering component parts to the recording unit 25. The surface interference determination unit 40 has a contour boundary interference determination unit 41, an inside/outside determination unit 42, an angle determination unit 43, and a target determination unit 44.

The contour boundary interference determination unit 41 compares a surface bounding volume of a surface divided from one of the component part having the possibility of interference with a surface bounding volume of a surface divided from another component part. In the case where there is an intersecting line in the surface bounding volumes, the two surfaces have the possibility of interference. The inside/outside determination unit 42 detects a secondary target line segment shared by the two surfaces from intersecting points of the surface bounding volumes and the contour lines of the two possibly interfering surfaces and detects the number of surfaces that has the secondary target line segment as the contour line.

In the case where the number of surfaces having the secondary target line segment as the contour line is 0, i.e. in the case where the two surfaces intersect with each other inside the contours, the inside/outside determination unit 42 records in the recording unit 25 the combination of component parts as interfering.

In the case where the number of surfaces having the secondary target line segment as the contour line is 2, i.e. in the case where the contours of the two surfaces are in contact with each other, the inside/outside determination unit 42 causes the angle determination unit 43 to perform interference determination.

In the case where the number of surfaces having the secondary target line segment as the contour line is 1, i.e. in the case where one of the contours of the surfaces contacts the other contour at the inside of the other contour, the inside/outside determination unit 42 causes the target determination unit 44 to perform interference determination.

The angle determination unit 43 refers to the line angle attributions of the contours of the surfaces contacting at the secondary target line segment and determines whether the combination of the component parts interfere with each other. In the case where the combination of the component parts interfere with each other, the angle determination unit 43 records the combination of the component parts in the recording unit 25.

The angle determination unit 43 refers to the line angle attributions of the contours of the surfaces contacting at the secondary target line segment and determines whether the combination of the component parts interfere each other. In the case where the combination of the component parts interfere with each other, the angle determination unit 43 records the combination of the component part in the recording unit 25.

The target determination unit 44 determines whether the combination of the component parts interfere each other by comparing a direction of the surface of which the contour is on the secondary target line segment with a normal line direction of the surface of which the contour is not on the secondary target line segment. In the case where the combination of the component parts interfere with each other, the target determination unit 44 records the combination of the component parts in the recording unit 25.

The recording unit 25 stores information of the interfering component parts. The output unit 26 performs a processing for outputting the information of the interfering component parts stored in the recording unit 25. More specifically, the output unit 26 may be a display displaying the information of the interfering component parts, or may be configured to provide the information of the interfering component parts for another device.

As described above, the interference determination device 2 determines the possibility of interference by the three-dimensional bounding volumes and divides the component parts of the combination having the possibility of interference into surfaces to perform the interference determination.

Determination by Three-dimensional Bounding Volume

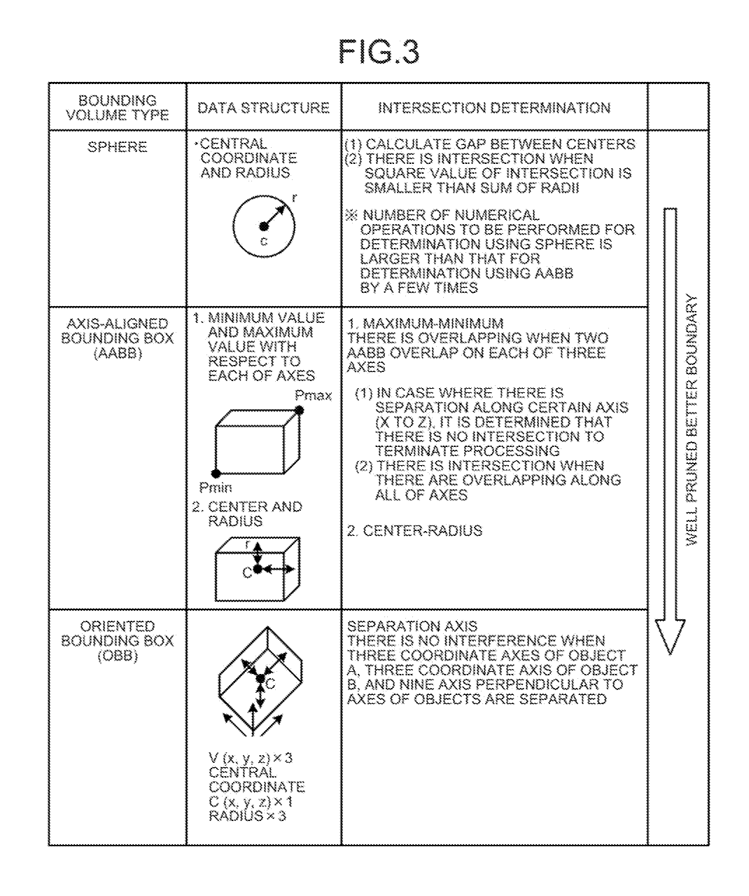

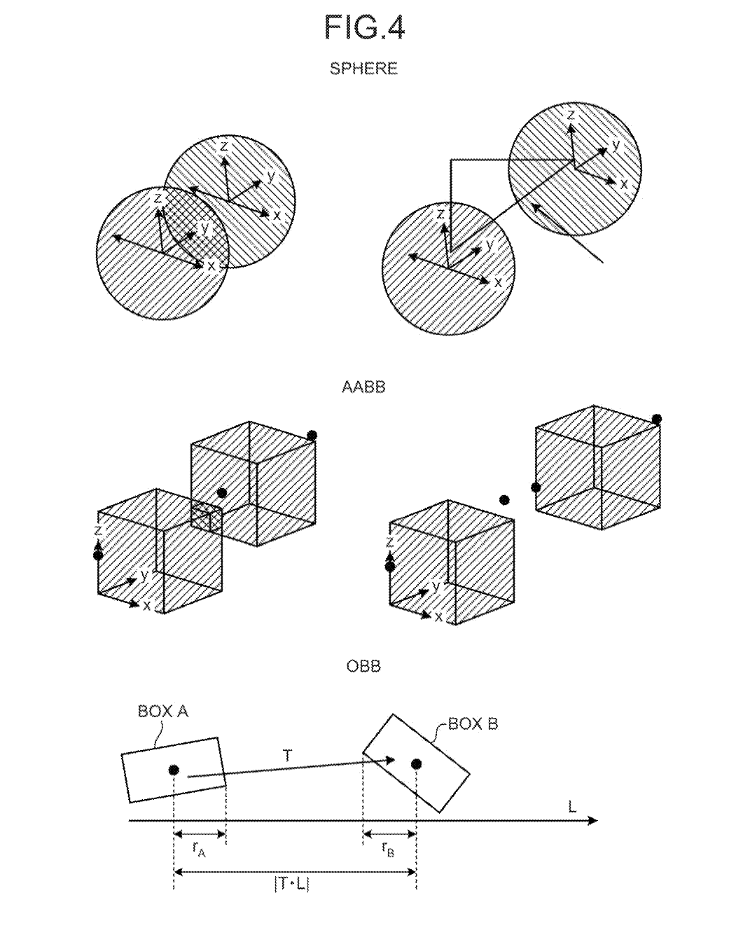

FIG. 3 is a diagram illustrating three-dimensional bounding volumes. FIG. 4 is a diagram illustrating interference determinations using the three-dimensional bounding volumes. As specific examples of the bounding volumes, SPHERE, Axis-Aligned Bounding Box (AABB), and Oriented Bounding Box (OBB) are illustrated in FIG. 3. In the examples, a degree of reflection of the shape of the target object and accuracy of intersection determination are in the ascending order of SPHERE, AABB, and OBB.

In the case where the bounding volume is SPHERE, a central coordinate (x,y,z) and a radius are included as a data structure of the bounding volume. In the case of determining an intersection of SPHERE bounding volumes, i.e. the interference, a distance between the centers is calculated, and it is determined that the SPHEREs intersect with each other when a square value of the distance is smaller than a sum of the radii. In the interference determination by SPHERE bounding volumes, the number of times of numerical calculation is larger than that performed in the determination of AABB by a few times.

In the case where the bounding volume is AABB, a data structure of the bounding volume has a minimum value and a maximum value with respect to each of axes (x,y,z). Alternatively, the center of the box and radii of the axes may be used as the data structure of the bounding volume.

In the case where the data structure of AABB is indicated by the maximum value and the minimum value, it is determined that there is no intersection when two AABBs in any one of the three axes are separated, while it is determined that there is interference when the AABBs overlap in all of the axes. Likewise, in the case where the AABB data structure is obtained by the center and the radii, intersection is determined when the AABBs overlap in all of the axes.

In the case where the bounding volume is Oriented Bounding Box (OBB), a data structure of the bounding volume is represented by three inclinations V(x,y,z), a central coordinate C(x,y,z), and three radii. In OBB, when three coordinate axes of a separation axis object A, three coordinate axes of an object B, and nine axes perpendicular to the axes of the objects are separated from one another, it is determined that there is no intersection.

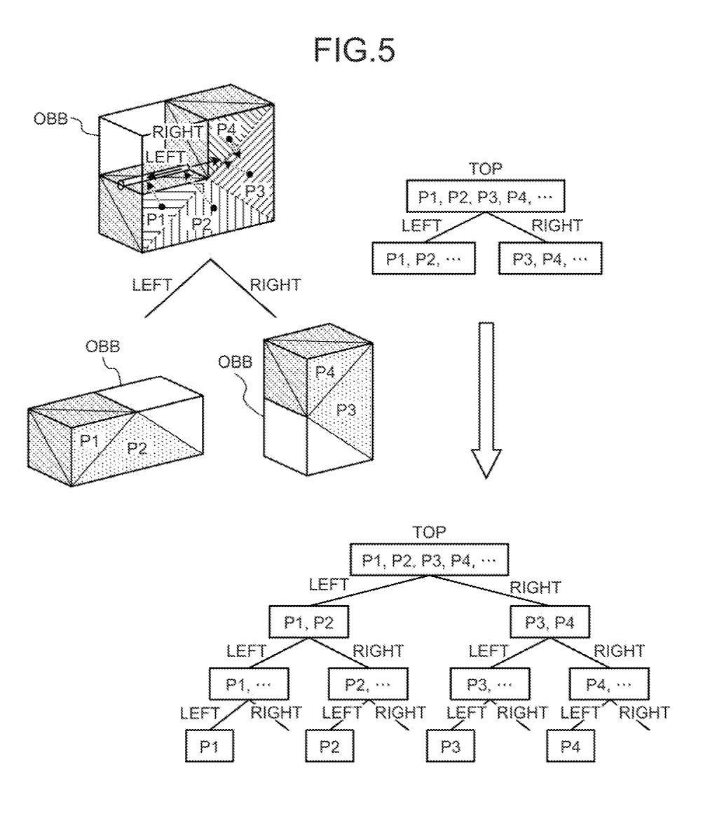

In simple interference determination of OBB, it is determined whether all of apexes of a box A are outside a surface defined by a surface of a box B. In a separation axis determination of OBB, as illustrated in FIG. 5, it is determined that two OBBs (box A, box B) are separated from each other in the case where a sum of radii (r_{A}+r_{B}) obtained by projecting the OBBs (box A, box B) to an axis (L) is shorter than a distance between the projected centers (|T·L|).

In the case where two bounding volumes interfere with each other, it is possible that objects enclosed in the bounding volumes interfere with each other. As a method for determining the interference of objects by using polygons, a method of determining intersection of line segments forming the objects, a method of determining whether or not an apex of one of the object is included in a region (space) of the other object (inclusion determination), or the like may be employed. Further, there has been known intersection determination in which it is determined whether a line segment or an apex of one of two objects overlaps with a line segment or an apex of the other object.

Hereinafter, hierarchization of a bounding volume will be described. FIG. 5 is a diagram illustrating the hierarchization of bounding volume. By arranging a bounding volume into a tree-form hierarchy structure (tree structure), it is possible to eliminate non-interference state at an earlier stage to make it possible to logarithmically reduce temporary complication of the number of determinations to be performed. The processing of approximating to a shape of an object by the hierarchization of bounding volume as described above is called pruning.

In general, in the case of emphasizing on accuracy and speed, the tree-form hierarchy structure is adapted to OBB. In the example illustrated in FIG. 5, the top OBB including the entire object is divided into two left and right OBBs. The top OBB includes the entire object. Therefore, all of polygons including polygons P1 to P4 exist inside the top OBB.

By forming the left OBB including the polygons P1 and P2 and the right OBB including the polygons P3 and P4 as a level subsequent to the top level in the object, it is possible to obtain a combination of bounding volumes which is closer to the shape of the object than the top OBB.

By repeating the hierarchization in the same manner to form OBB including the polygon P1, OBB including the polygon P2, OBB including the polygon P3, and OBB including the polygon P4, it is possible to obtain a combination of bounding volumes which is much closer to the shape of the object.

However, since the arrangement of OBB in the tree-form hierarchy structure (tree structure) means formation of OBBs in each of the levels, the creation of OBBs in the pre-processing that is performed before the polygon interference check increases memory consumption and creation time.

Further, in recent years, a detailed model is prepared for a shape of an object. Therefore, since even a small device increases memory consumption, there is a possibility that a model exceeding a limit memory space of a 32-bit OS exists when memory consumption is increased by the interference check.

Since the round-robin interference determination by the unit of polygons entails high calculation load and consumes long processing time, the bounding volume is used for improving the processing speed. However, the use of bounding volume having the tree structure causes the increase in memory consumption.

In the case of using OBB, when a polygon shape is divided to obtain tree structure OBBs including the divided polygons, the memory consumption is increased to about 2 to 10 times of the memory consumption depending on complication of the model, compared to the case using only the polygon shape.

Further, in recent years, for the purpose of further improvement in processing speed, the improvement in processing speed has been attained by reducing the total number of OBBs to be created by reducing a difference between the OBBs and the model shape by dividing the OBBs by the unit of surface after the first OBB division creation. However, since such processing requires the OBB creation to the edge, the memory consumption by the OBBs is still large. Additionally, in the case of the unit of surface, since it is ambiguous whether or not a surface contacting another surface interferes, it has been necessary to perform checking using adjacent polygons.

In contrast, in the disclosed technology, OBB is creased only by the unit of surface, and the detailed check is performed by using the intersection line segment of the surfaces, thereby reducing the bounding volume creation. In other words, in the disclosed technology, in order to suppress the memory consumption while maintaining the processing speed, the OBB creation is performed by the unit of surface (the unit of a class of polygons having identical normal line among adjacent polygons), and the OBB creation to the edge is not required. More specifically, OBBs are not arranged in the tree form hierarchy structure (tree structure), but OBB is expanded in one level and without creating OBB existing in an intermediate level. The interference check per se is performed by using intersection line segments of surfaces and the outer line and the inner line of a surface shape.

Thus, it is possible to reduce the number of OBBs to be created and time required for moving to the edge of hierarchy, and it is possible to largely suppress the memory consumption while maintaining or reducing the processing speed. The outer line means a boundary of a closed loop inside which a polygon exists when the closed loop is formed by continuously connecting edges of polygons that are not shared. The inner line means a boundary of the closed loop outside which a polygon exists. A surface boundary, i.e. OBB that has no thickness, is referred to as Oriented Bounding Surface (OBS).

### Specific Example

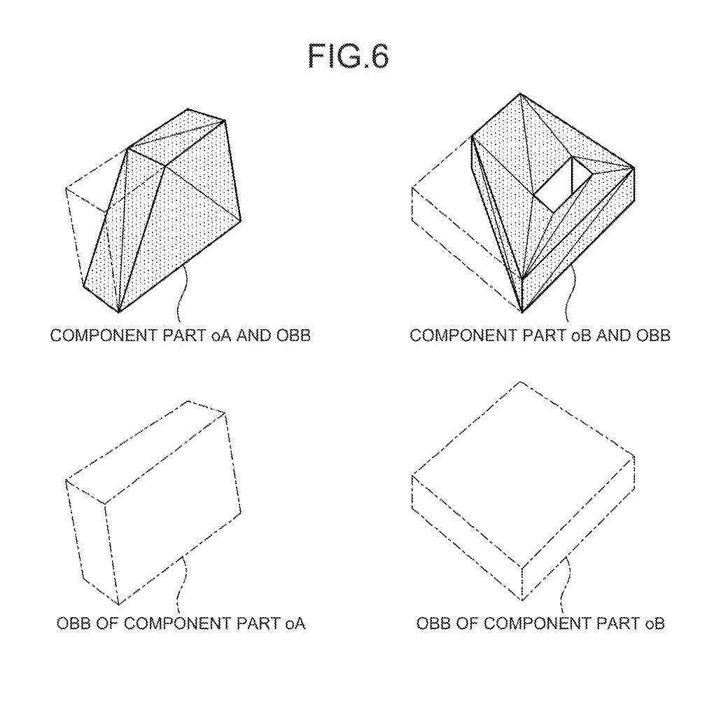

FIG. 6 is a diagram illustrating creation of OBBs of component parts. FIG. 6 is one example of three-dimensional OBBs to be created by the component part bounding volume management unit 22. The component part bounding volume management unit 22 creates OBB of a model outer shape for each of a component part oA and a component part oB. The conventional technologies may be employed for creating the OBBs.

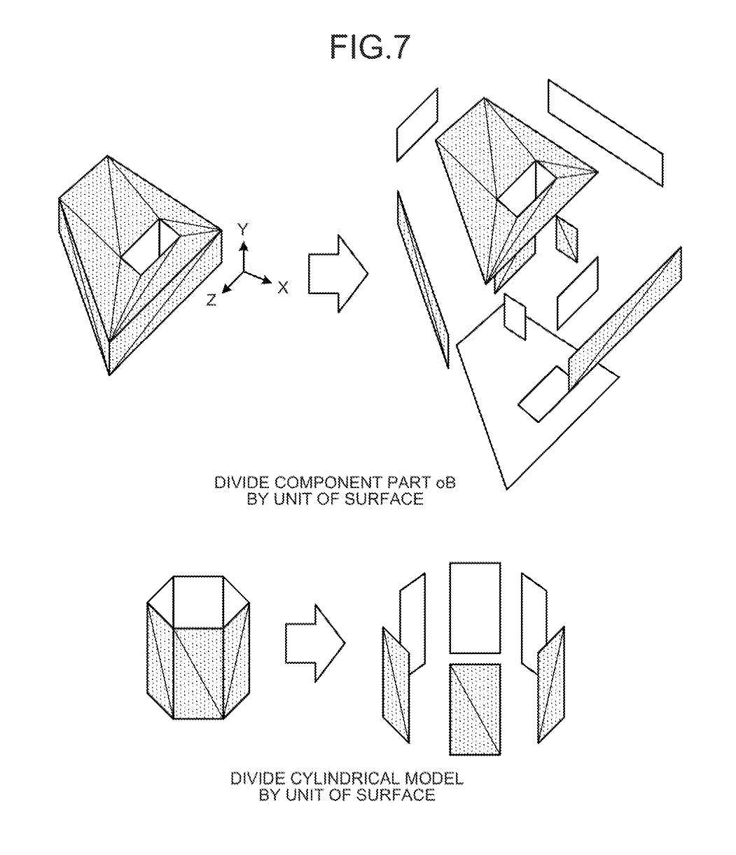

FIG. 7 is a diagram illustrating specific examples of division. The dividing unit 23 divides the model (component part) by the unit of surface shape and places the divided surfaces under the OBB of the model (component part) outer shape. Here, a class of polygons having an identical normal line among adjacent polygons is used as an identical surface. In FIG. 7, division of the component part oB and division of a cylindrical model are exemplified.

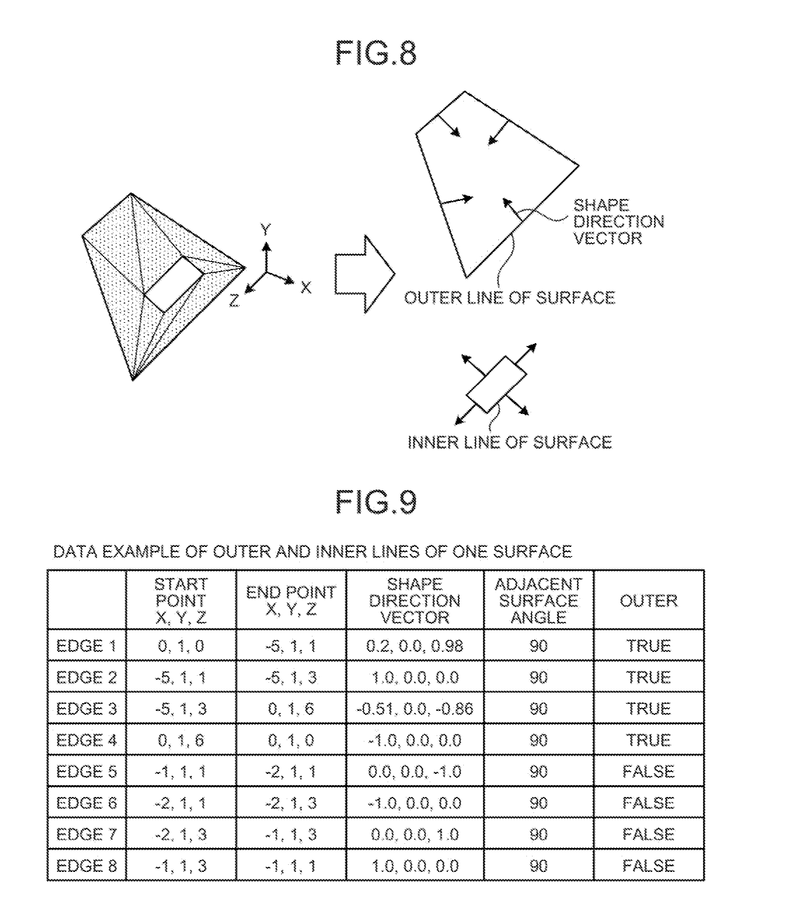

FIG. 8 is a diagram illustrating generation of contour line and attribution. The contour line generation unit 31 generates a contour from the surfaces created by the dividing unit 23. More specifically, the contour line generation unit 31 successively finds boundaries that are not shared by different polygons on a surface to form a closed loop and sets the closed loop as a contour line. In the example illustrated in FIG. 8, the surface has the outside contour and the inside contour. The outside contour line is referred to as the outer line of the surface shape, and the inside contour line is referred to as the inner line.

The line attribution generation unit 33 imparts attribution indicating whether the outer line or the inner line to the contour line. More specifically, based on the created closed loop of the contour, the line attribution generation unit 33 sets and extracts the case where a polygon exist inside the boundary as outer and sets the case where a polygon exists outside the boundary as inner. Further, the line attribution generation unit 33 sets a unit vector that is perpendicular to the boundary in a direction of existence of polygon and indicates a shape direction on the surface for each of the boundaries.

FIG. 9 is diagram illustrating specific examples of line data. The examples illustrated in FIG. 9 illustrate the contour lines Edge 1 to Edge 8 obtained from a surface of FIG. 8, and each of the contour lines has items of a start point coordinate (X,Y,Z), an end point coordinate (X,Y,Z), a shape direction vector, an adjacent surface angle, and outer. The start point coordinate (X,Y,Z), the end point coordinate (X,Y,Z), and the shape direction vector are based on an original point of the model. Further, the item of outer takes a value of True when the contour line is the outer line and a value of False when the contour line is the inner line.

In the example illustrated in FIG. 9, the contour line Edge 1 has the start point coordinate (X,Y,Z) of (0,1,0), the end point coordinate (X,Y,Z) of (−5,1,1), the shape direction vector of (0.2,0.0,0.98), the adjacent surface angle of 90 degrees, and the outer value of True.

The contour line Edge 2 has the start point coordinate (X,Y,Z) of (−5,1,1), the end point coordinate (X,Y,Z) of (−5,1,3), the shape direction vector of (1.0,0.0,0.0), the adjacent surface angle of 90 degrees, and the outer value of True. The contour line Edge 3 has the start point coordinate (X,Y,Z) of (−5,1,3), the end point coordinate (X,Y,Z) of (0,1,6), the shape direction vector of (−0.51,0.0,0.86), the adjacent surface angle of 90 degrees, and the outer value of True.

The contour line Edge 4 has the start point coordinate (X,Y,Z) of (0,1,6), the end point coordinate (X,Y,Z) of (0,1,0), the shape direction vector of (−1.0,0.0,0.0), the adjacent surface angle of 90 degrees, and the outer value of True. The contour line Edge 5 has the start point coordinate (X,Y,Z) of (−1,1,1), the end point coordinate (X,Y,Z) of (−2,1,1), the shape direction vector of (0.0,0.0,−1.0), the adjacent surface angle of 90 degrees, and the outer value of False.

The contour line Edge 6 has the start point coordinate (X,Y,Z) of (−2,1,1), the end point coordinate (X,Y,Z) of (−2,1,3), the shape direction vector of (−1.0,0.0,0.0), the adjacent surface angle of 90 degrees, and the outer value of False. The contour line Edge 7 has the start point coordinate (X,Y,Z) of (−2,1,3), the end point coordinate (X,Y,Z) of (−1,1,3), the shape direction vector of (0.0,0.0,1.0), the adjacent surface angle of 90 degrees, and the outer value of False. The contour line Edge 8 has the start point coordinate (X,Y,Z) of (−1,1,3), the end point coordinate (X,Y,Z) of (−1,1,1), the shape direction vector of (1.0,0.0,0.0), the adjacent surface angle of 90 degrees, and the outer value of False.

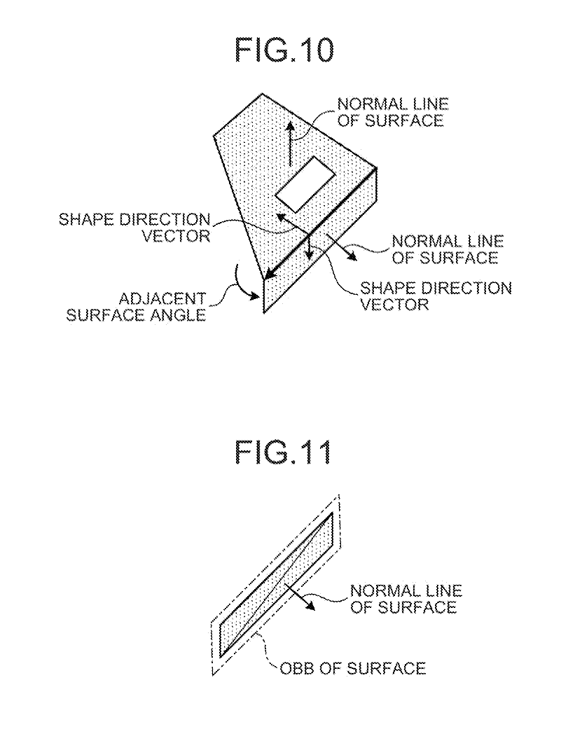

Hereinafter, calculation of the adjacent surface angle illustrated in FIG. 9 will be described. FIG. 10 is a diagram illustrating calculation of a contour surface angle. The adjacent surface angle is detected by the line angle attribution generation unit 34. More specifically, the line angle attribution generation unit 34 calculates an outer product of a normal line of a target surface and a shape direction vector of a boundary to temporarily decide a rotation axis direction. Next, the line angle attribution generation unit 34 extracts an angle by calculating an outer product of the shape direction vector of the boundary of the target surface and a shape direction vector of a boundary of an adjacent surface. In the case where the vector direction of the outer product is the same as the temporarily calculated outer product, the line angle attribution generation unit 34 uses the value as it is. In the case where the vector directions are different from each other, an angle of 180 degrees is added to extract an angle of the adjacent surface from the current surface. When there are different adjacent surfaces on one boundary, the boundary is divided to be managed.

The division suitability determination unit 32 counts boundaries belonging to one surface shape, and the surface is divided for performing the same processing again in the case where the number of boundaries is larger than a predetermined value. When the attribution of the surface shape is obtained, the surface bounding volume management unit 35 creates surface OBB, i.e. OBS, as illustrated in FIG. 11. OBS has a shape of OBB that lacks one axial component part (one axis out of three axes).

The above-described processing is repeated until no surface of the target model (component part) is left unprocessed and then repeated until no model (assembly, component part) is left unprocessed, thereby creating all of OBBs and OBSs. The all of OBBs and OBSs are created by using local coordinate systems of the component part.

Hereinafter, the interference check will be described. In the interference check, an interference check is performed on OBBs by the unit of model (assembly, component part), and an interference check is performed on OBSs of surfaces of the interfering models.

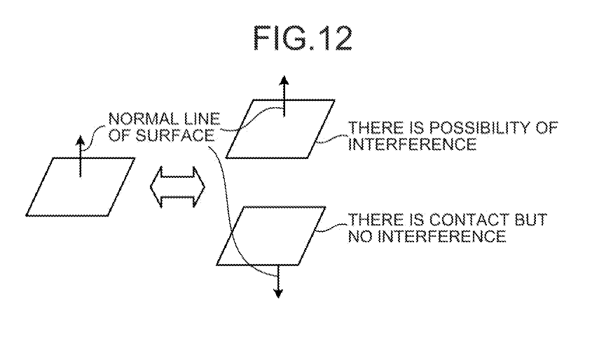

In the interference check of OBSs, normal line directions of two surfaces are checked. As illustrated in FIG. 12, it is determined that there is no interference when the normal line directions of the two surfaces are precisely opposite from each other. There is the possibility of interference when the normal line directions are the same.

As to the OBSs having the possibility of interference, it is checked whether or not creation of a separation axis is possible in the same manner as in the ordinary OBBs, and it is determined that there is the possibility of interference when it is impossible to create the separation axis. In the intersection determination, local coordinates of the OBBs and OBSs of the component parts are converted into absolute coordinates.

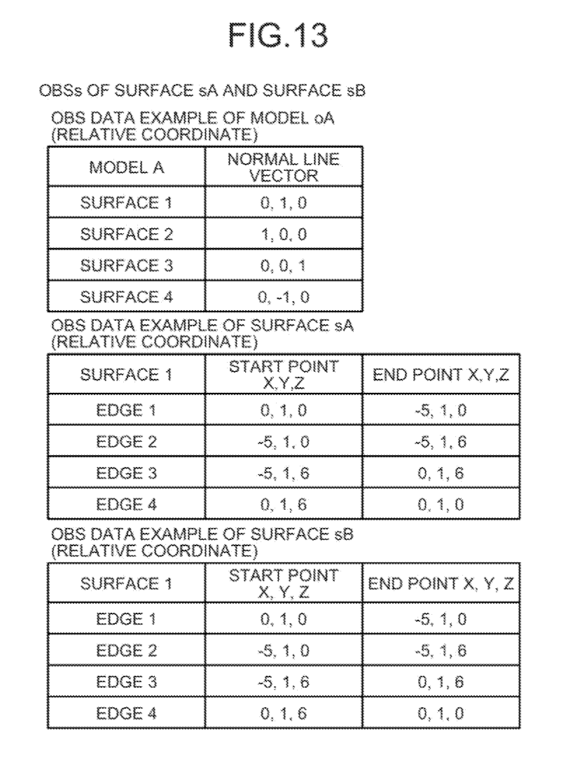

Illustrated in FIG. 13 is specific examples of OBS data. In the examples illustrated in FIG. 13, the model oA has Surface 1 having a normal line vector of (0,1,0), Surface 2 having a normal line vector of (1,0,0), Surface 3 having a normal line vector of (0,0,1), and Surface 4 having a normal line vector of (0,−1,0) in a relative coordinate.

Further, Surface 1 of the model oA has Edge 1 having a start point (X,Y,Z)=(0,1,0) and an end point (X,Y,Z)=(−5,1,0), Edge 2 having a start point (X,Y,Z)=(−5,1,0) and an end point (X,Y,Z)=(−5,1,6), Edge 3 having a start point (X,Y,Z)=(−5,1,6) and an end point (X,Y,Z)=(0,1,6), Edge 4 having a start point (X,Y,Z)=(0,1,6) and an end point (X,Y,Z)=(0,1,0) in the relative coordinate.

Likewise, Surface 1 of the model oB has Surface 1 having Edge 1 having a start point (X,Y,Z)=(0,1,0) and an end point (X,Y,Z)=(−5,1,0), Edge 2 having a start point (X,Y,Z)=(−5,1,0) and an end point (X,Y,Z)=(−5,1,6), Edge 3 having a start point (X,Y,Z)=(−5,1,6) and an end point (X,Y,Z)=(0,1,6), Edge 4 having a start point (X,Y,Z)=(0,1,6) and an end point (X,Y,Z)=(0,1,0) in the relative coordinate.

In the interference check using separation axis, the OBS data are converted into the absolute coordinates to calculate the separation axis. In the case where there is the possibility of interference as a result of the interference check using separation axis, the contour boundary interference determination unit 41 extracts an intersection line of the two OBSs.

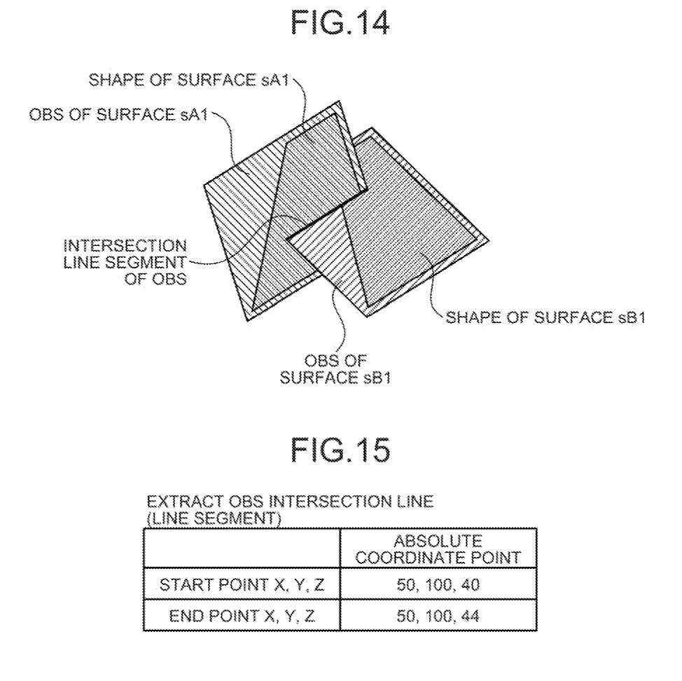

FIG. 14 is a diagram illustrating calculation of the intersection line of OBSs, and FIG. 15 is a diagram illustrating one specific example of OBS intersection line data. In the example illustrated in FIG. 14, an intersection line between OBS of a surface sA1 which is one of the model oA and OBS of a surface sB1 which is one of surfaces of the model oB, i.e. an intersection line segment, is illustrated.

As illustrated in FIG. 15, in the intersection line data of OBS, the coordinate of the start point and the coordinate of the end point are represented by absolute coordinates. In the example illustrated in FIG. 15, the absolute coordinate of the start point is (X,Y,Z)=(50,100,40), and the absolute coordinate of the end point is (X,Y,Z)=(50,100,44).

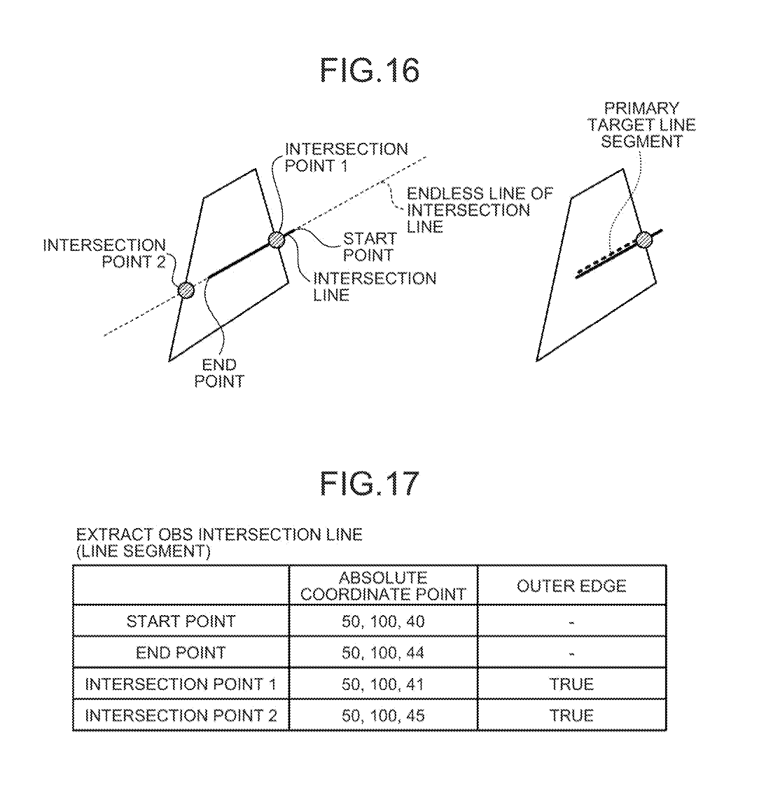

The inside/outside determination unit 42 extracts intersection points between the extracted intersection line and an outer and an inner of a counter surface. Here, the intersection points are extracted by using the intersection line as an endless line segment. FIG. 16 is a diagram illustrating one specific example of the extraction of intersection points. In the example illustrated in FIG. 16, the intersection point 1 exists between the start point and the end point of the intersection line, and the intersection point 2 exists on an extended line on the side of the end point.

The inside/outside determination unit 42 extracts coordinates of the start point, the end point, and the intersection points. FIG. 17 is a diagram illustrating one example of coordinate data of the start point, the end point, and the intersection points of the intersection line. In the example illustrated in FIG. 17, the coordinates of the start point and the end point are as illustrated in FIG. 15, and the absolute coordinates of the intersection point 1 and the intersection point 2 are (X,Y,Z)=(50,100,41) and (X,Y,Z)=(50,100,45), respectively. The intersection point 1 and the intersection point 2 are points of intersection with the outer line.

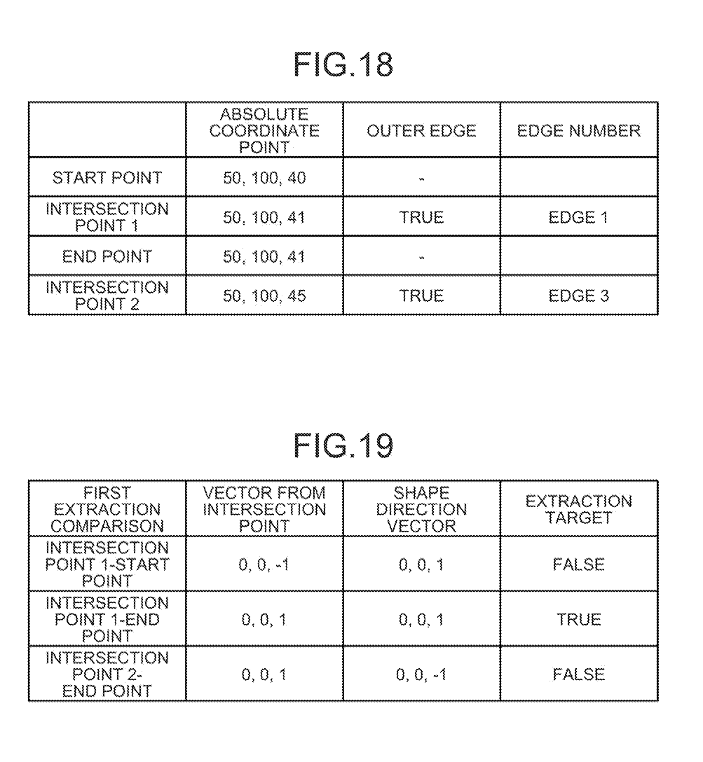

The inside/outside determination unit 42 extracts a primary line segment by rearranging the start point, the end point, and the intersection points of the intersection line. FIG. 18 is a diagram illustrating coordinate data of the rearranged start point, end point, and intersection points. In the example illustrated in FIG. 18, the start point, the intersection point 1, the end point, and the intersection point 2 are arranged in this order. The rearrangement order corresponds to the state illustrated in FIG. 16.

The inside/outside determination unit 42 determines whether gaps between the start point and end point and the intersection points are in the surface shape of the surface sA1. The determination is conducted by comparing a direction of the next point as viewed from each of the points with a shape direction vector direction of an edge in which the intersection point exists. More specifically, the case in which the vector from the intersection point forms 90 degrees or less at each side with respect to the shape vector is the case in which the gaps are inside the surface shape of the surface sA1, and the line segment is the target of extraction as the primary target line segment.

FIG. 19 is a diagram illustrating result data of the comparison of whether the gaps between the start point and end point and the intersection points are inside the surface shape of the surface sA1. As illustrated in FIG. 19, the gap between the intersection point 1 and the start point is represented by the vector from the intersection point of (0,0,−1), the shape direction vector of (0,0,1), and the extraction target is False. Therefore, the gap between the intersection point and the start point does not exist inside the surface shape of the surface sA1.

The gap between the intersection point 1 and the end point is represented by the vector from the intersection point of (0,0,1), the shape direction vector of (0,0,1), and the extraction target is True. Therefore, the gap between the intersection point and the end point exists inside the surface shape of the surface sA1.

The gap between the intersection point 2 and the end point is represented by the vector from the intersection point of (0,0,1), the shape direction vector of (0,0,−1), and the extraction target is False. Therefore, the gap between the intersection point and the end point does not exist inside the surface shape of the surface sA1.

The inside/outside determination unit 42 records a line segment as the primary target line segment when the line segment is inside the shape direction, i.e. when the extraction target is True. After that, the processing is repeated for the current intersection point and the subsequent intersection point in the same manner to the edge point.

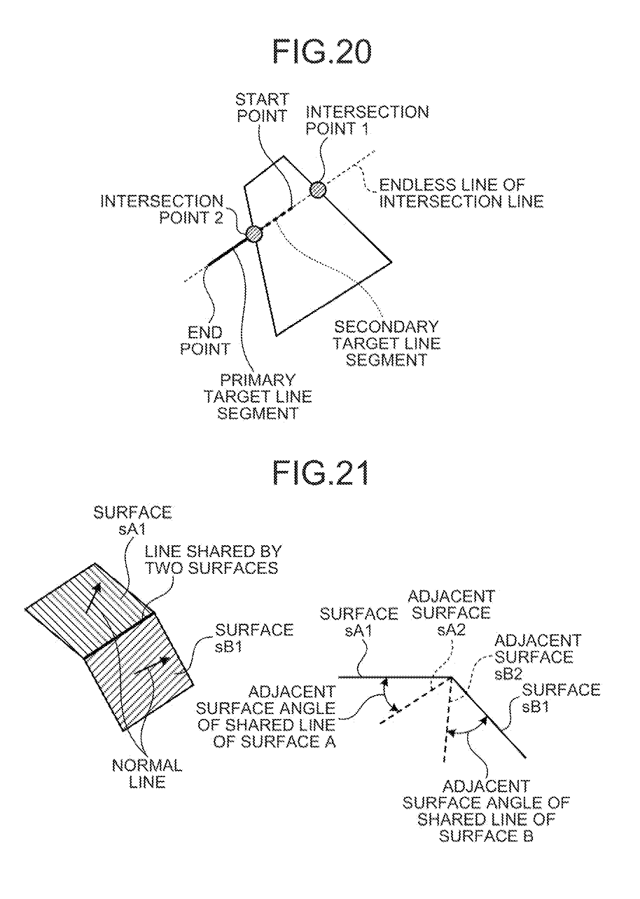

The inside/outside determination unit 42 uses the extracted primary target line segment to perform the same processing on an outer and an inner of the other surface and sets an ultimately left line segment as a secondary target line segment. FIG. 20 is a diagram illustrating the extraction of the secondary target line segment. An overlapping portion between an intersection line of two OBSs each including a surface and one of the surfaces is the primary target line segment. In other words, the primary target line segment is the overlapping portion between one of the surfaces and the other OBS. The secondary target line segment is an overlapping portion between the primary target line segment and the other surface. In other words, the secondary target line segment is an overlapping portion of the two surfaces. In the example illustrated in FIG. 20, the gap between the start point and the intersection point 2 is the secondary objet line segment.

The inside/outside determination unit 42 checks each of the secondary target line segments as to weather the secondary target line segment is on the outer or inner of each of the surfaces. In the case where the secondary target line segment does not exist in the two surfaces, the inside/outside determination unit 42 records the secondary target line segment as an interfering line segment.

In the case where the secondary target line segment exists on the two surfaces, the angle determination unit 43 determines whether or not there is interference by extracting an adjacent surface angle from the outer and the inner belonging to the secondary target line segment. FIG. 21 is a diagram illustrating the determination by the angle determination unit 43.

In the example illustrated in FIG. 21, the angle determination unit 43 sets the surface sA1 to 0 degree to extract an adjacent angle of a boundary of the surface sA1, i.e. an angle formed by the surface sA1 and an adjacent surface sA2 of the identical component part. Next, an outer product of a normal line of the surface sA1 and a shape direction vector of the boundary is calculated to temporarily decide a rotation axis direction. After that, an outer product is calculated by using the shape direction vector of the boundary of the surface sA1 and a shape direction vector of a boundary of the surface sB1 to extract the angle. The value is used as it is in the case where the vector direction of the outer product is the same as that of the temporarily calculated outer product, while an angle 180 degrees is added to the value when the vector directions are different.

An outer product of the normal line of the surface sB1 and the shape direction vector of the boundary is calculated to temporarily decide a rotation axis direction. The adjacent angle of the surface sB1, i.e. the angle formed by the surface sB1 and an adjacent surface sB2 of the identical component part, is added to perform extraction in the case where the axis direction of the surface sA1 and the axis direction of the surface sB1 are different from each other, while the extraction is performed by subtracting the angle when the axis directions are identical to each other. Thus, presence/absence of interference is determined from connection angles of the surfaces based on the surface sA1. In the case where there is interference, the secondary target line segment is recorded as the interfering line segment.

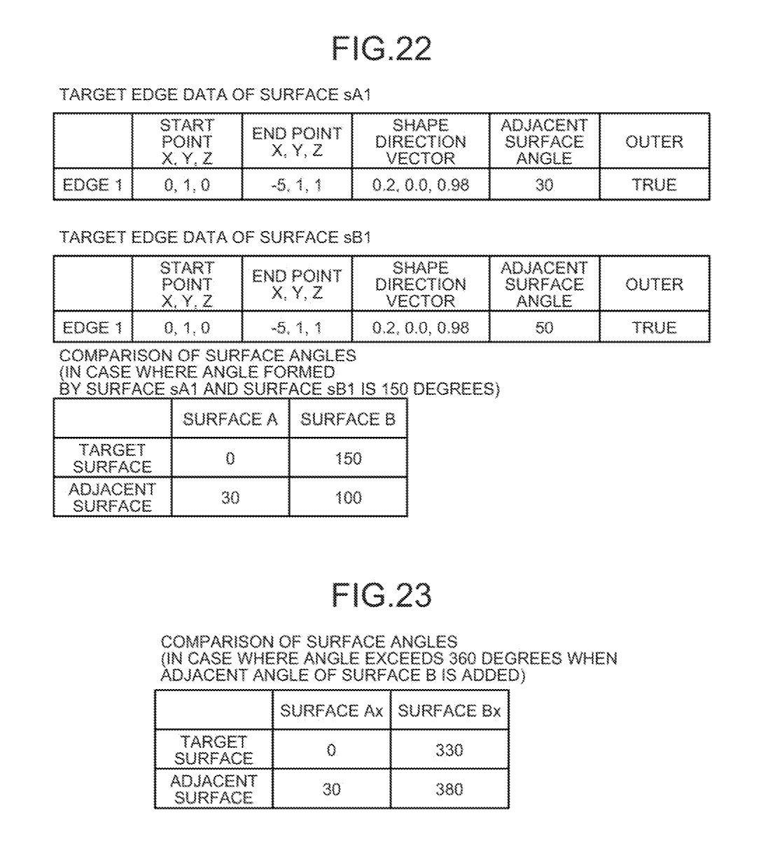

FIG. 22 is a diagram illustrating data examples of surfaces and specific examples of surface angles to be used by the angle determination unit 43. In the example illustrated in FIG. 22, Edge 1 of the surface sA1 and Edge 1 of the surface sB1 are in contact with each other. Edge 1 of the surface sA1 has a start point coordinate (X,Y,Z)=(0,1,0), an end point coordinate (X,Y,Z)=(−5,1,1), a shape direction vector of (0.2,0.0,0.98), an adjacent surface angle of 30 degrees, and outer of True. Edge 1 of the surface sB1 has a start point coordinate (X,Y,Z)=(0,1,0), an end point coordinate (X,Y,Z)=(−5,1,1), a shape direction vector of (0.2,0.0,0.98), an adjacent surface angle of 50 degrees, and outer of True.

When the surface angles of the surface sA1 and the surface sB1 are compared with each other, the surface sA1 serving as a target surface has 0 degree, and the surface sB1 serving as a target surface has 150 degrees. Further, the angle of the surface sA2 which is the adjacent surface of the surface sA1 is 30 degrees, and the angle of the surface sB2 which is the adjacent surface of the surface sB1 is 100 degrees. The range from the lowest value to the highest value of the angles of the target surfaces and the adjacent angles is set as a range within which the component parts exist. More specifically, 0 to 30 degrees is the range in which the component part having the surface sA1 exists, and 100 to 150 degrees is the range in which the component part having the surface sB1 exists. As a result of comparing the angle ranges, the angle determination unit 43 determines that there is interference when the overlapping range exists.

FIG. 23 is a diagram illustrating one specific example of the comparison by the angle determination unit 43. In the example of FIG. 23, a case in which the angle exceeds 360 degrees when an adjacent angle of a surface Bx is added is illustrated. More specifically, when a surface Ax is 0 degree in target surfaces of the surface Ax and the surface Bx, an adjacent surface of the surface Ax has 30 degrees, the surface Bx has 330 degrees, and an adjacent surface of the surface Bx has 380 degrees. In the case where the upper limit value exceeds 360 degrees as described above, the angle determination unit 43 performs the determination after subtracting 360 degrees from the angle formed by the surface Bx and the adjacent surface. Therefore, the interference determination is performed by setting the angle range of the component part having the surface Ax to 0 to 30 degrees and setting the angle range of the component part having the surface Bx to −30 to 20 degrees.

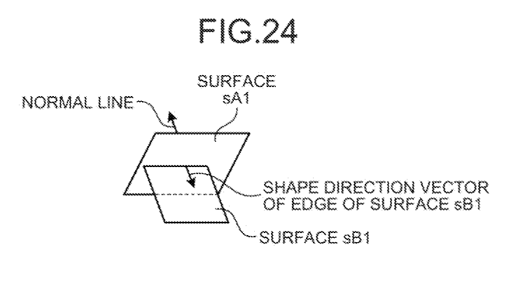

In the case where the secondary target line segment exists only on one of the surfaces as a result of the determination by the inside/outside determination unit 42, the target determination unit 44 determines whether or not there is interference. FIG. 24 is a diagram illustrating the determination by the target determination unit 44. The target determination unit 44 extracts a shape direction vector of an outer line or an inner line overlapping with the target secondary target line segment to compare with a normal line of the other surface. It is determined that there is interference in the case where a difference from the normal line is 90 degrees or more, and the secondary target line segment is recorded as an interfering line segment when the interference is determined.

In the example illustrated in FIG. 24, the angle is extracted from an inner product of a normal line vector of the surface sA1 and a shape direction vector of a target edge on the surface sB1 in an absolute coordinate system. In the example illustrated in FIG. 24, since a boundary of the surface sB1 contacts a reverse surface of the surface sA1, the target determination unit 44 determines that there is interference.

Processing Flowchart

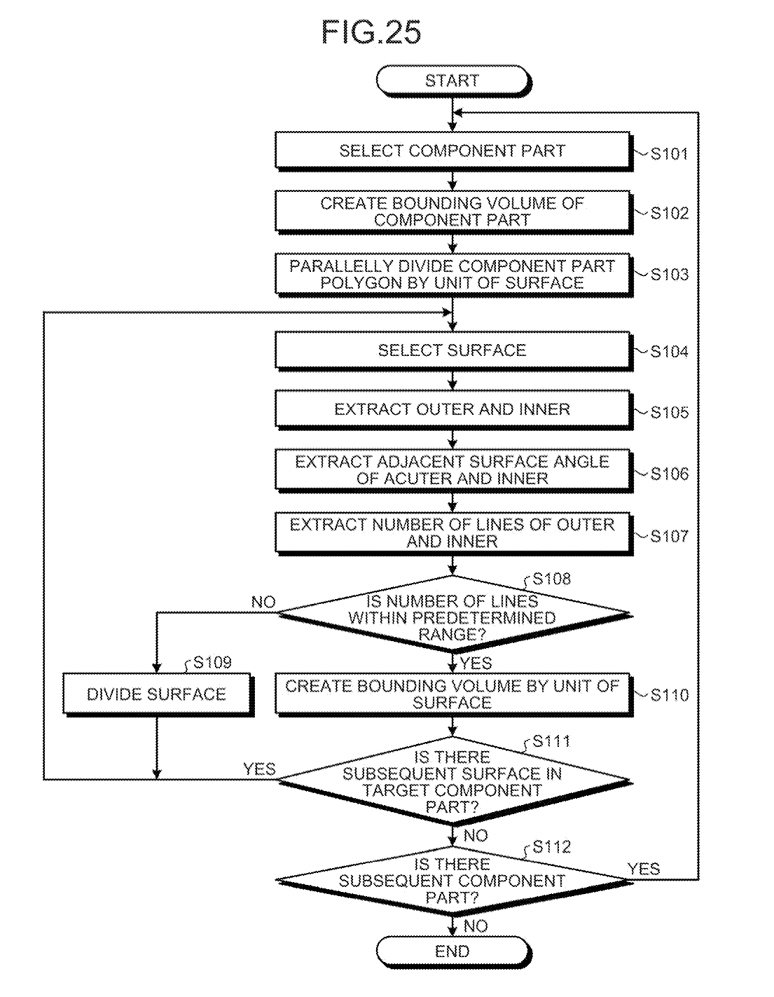

FIG. 25 is a flowchart illustrating creation of OBSs. The component part bounding volume management unit 22 selects a component part from the model database 21 (S101) and creates a three-dimensional bounding volume of the selected component part, such as OBB (S102).

The dividing unit 23 divides a polygon of the component part selected by the component part bounding volume management unit 22 by the unit of parallel surface (S103). The surface information creation unit 30 selects one of the surfaces obtained by the division (S104). The contour line generation unit 31 creates a contour line of the selected surface, and the line attribution generation unit 33 creates attribution of the line, thereby extracting an outer line and an inner line (S105).

The line angle attribution generation unit 34 extracts an adjacent surface angle between the outer line and the inner line (S106). The division suitability determination unit 32 extracts the number of lines of outer and inner (S107) to determine whether or not the number of lines is within the predetermined range (S108). In the case where the number of lines is not within the predetermined range (No in S108), the dividing unit 23 further divides the selected surface (S109), and the processing returns to Step S104. In the case where the number of lines is within the predetermined range (Yes in S108), the surface bounding volume management unit 35 creates a surface bounding volume (OBS) enclosing the selected surface (S110).

After the creation of OBS, in the case where a surface of which OBS is not created remains in the selected component part (Yes in S111), the processing returns again to Step S104. When OBS is created for each of the surfaces of the selected component part (No in S111), the component part bounding volume management unit 22 determines whether or not there is a component part for which OBS creation is not performed (S112). In the case where there is the component part for which OBS is not created (Yes in S112), the component part bounding volume management unit 22 returns to Step S101 to perform the component part selection. When OBS is created for each of the component parts registered in the model database 21 (No in S112), the processing is brought to an end.

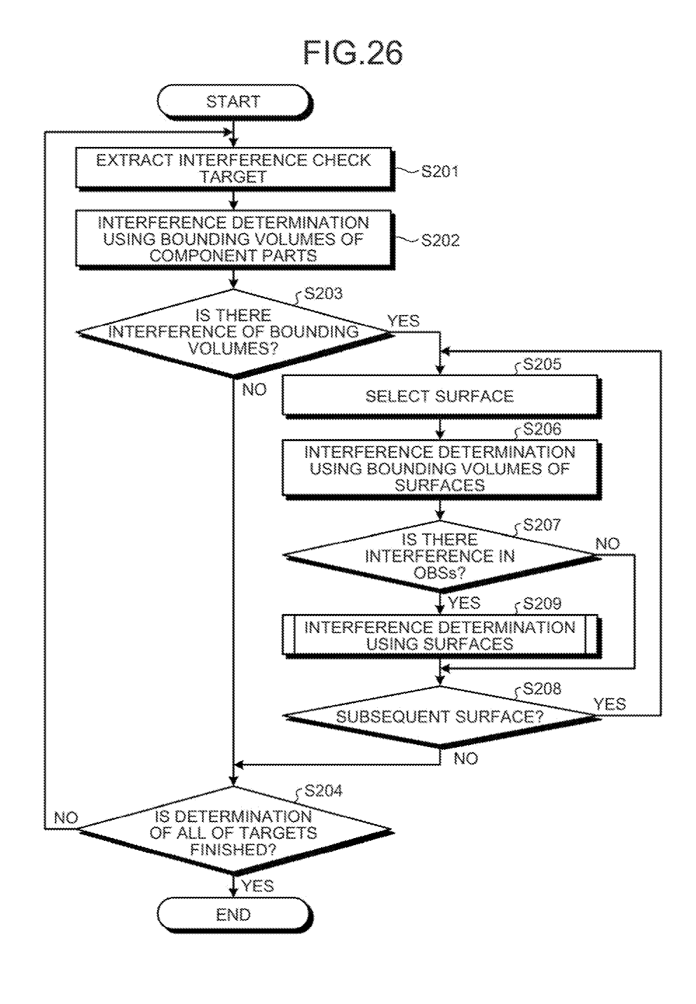

FIG. 26 is a flowchart illustrating the interference determination processing. The bounding volume interference determination unit 24 selects two component parts from component parts registered in the model database 21 to use them as interference check targets (S201). The bounding volume interference determination unit 24 performs on the two component parts selected as the interference check targets the interference determination using bounding volumes created by the component part bounding volume management unit 22 (S202).

In the case where the bounding volumes interfere with each other (Yes in S203), the surface interference determination unit 40 selects one surface from each of the two component parts selected as the interference check targets (S205) to perform the interference determination by using the bounding volumes (OBSs) of the surfaces (S206). In the case where there is the interference between the OBSs as a result of the determination (Yes in S207), the surface interference determination unit 40 executes the interference determination using surfaces (S209).

After the interference determination using surfaces (S209) or in the case where there is no interference in the OBSs (No in S207), the surface interference determination unit 40 determines whether or not a surface on which the determination is not performed remains in the component part of the interference check targets (S208). In the case where there is the surface on which the determination is not performed (Yes in S208), the surface interference determination unit 40 returns to Step S205 to perform the surface selection.

In the case where there is no interference in the bounding volumes (No in S203) or in the case where the surface interference determination unit 40 has performed the determination on each of the surfaces of the component part pats of the interference check targets (No in S208), the bounding volume interference determination unit 24 determines whether or not the interference determination is performed on each of combination of the component parts registered in the model database 21 (S204). In the case where the combination of component parts on which the interference determination is not performed remains (No is S204), the bounding volume interference determination unit 24 returns to Step S201 to perform the component part selection. In the case where the interference determination is performed on each of the combination of the entire component parts (Yes in S204), the processing is brought to an end.

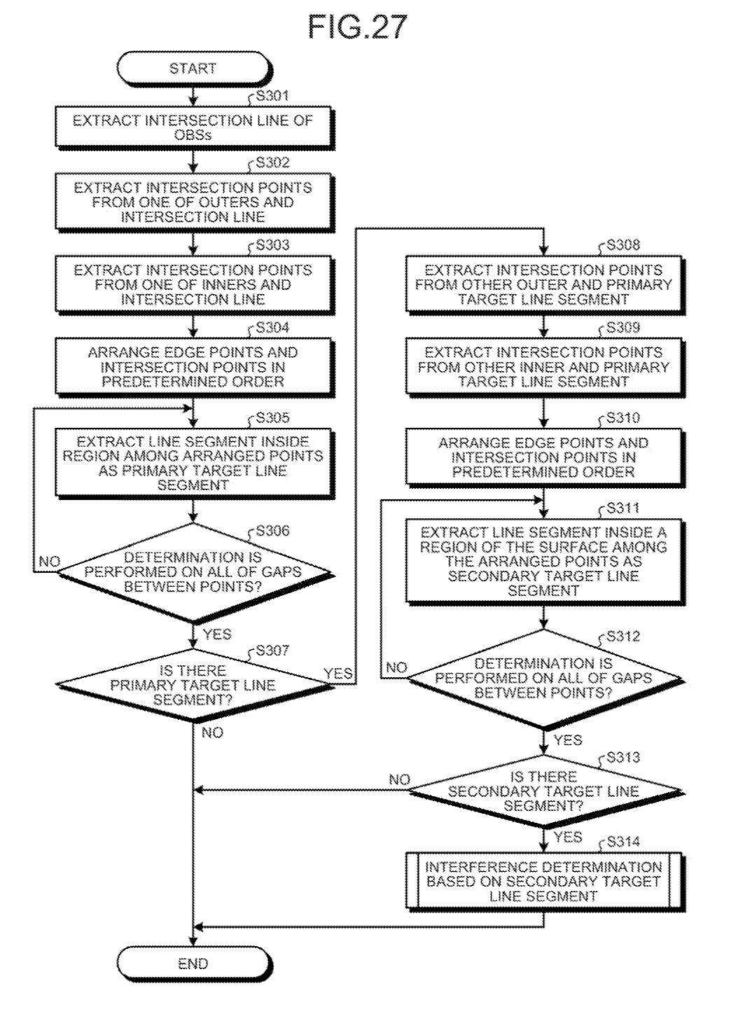

FIG. 27 is a flowchart illustrating the interference determination processing using surface illustrated in FIG. 26. When the interference determination processing using surface is started, the contour boundary interference determination unit 41 extracts an intersection line of two OBSs (S301). The inside/outside determination unit 42 extracts an intersection point from the outer line of one of the surfaces and the intersection line of OBSs (S302) and extracts an intersection point from the inner line of the same surface and the intersection line of the OBSs (S303).

The inside/outside determination unit 42 arranges edge points, i.e. a start point and an end point, and the intersection points in the predetermined order (S304) and extracts a line segment inside a region of the surface among the arranged points as a primary target line segment (S305). In the case where the determination is not performed on all of gaps between the points (No in S306), the inside/outside determination unit 42 returns to step S305 to repeat the processing. After performing the determination on all of the gaps between the points (Yes in S306), it is determined whether or not there is the primary target line segment (S307).

In the case where there is the primary target line segment (Yes in S307), the inside/outside determination unit 42 extracts an intersection point between the outer line of the other surface and the primary target line segment (S308) and extracts an intersection point from the inner line of the same surface and the primary target line segment (S309).

The inside/outside determination unit 42 arranges the edge points and the intersection points in the predetermined order (S310) and extracts a line segment among the arranged points in the region of the surface as a secondary target line segment (S311). In the case where the determination has not been performed on all of gaps between the points (No in S312), the inside/outside determination unit 42 returns to Step S311 to repeat the processing. After performing the determination on all of the gaps between the points (Yes in S312), the inside/outside determination unit 42 determines whether or not there is the secondary target line segment (S313).

In the case where there is the secondary target line segment (Yes in S313), the inside/outside determination unit 42 executes interference determination based on the secondary target line segment (S314) to bring the interference determination processing using surface to an end. Further, in the case where there is no primary target line segment (No in S307) or there is no secondary target line segment (No in S313), the inside/outside determination unit 42 brings the inference termination processing to an end at the step.

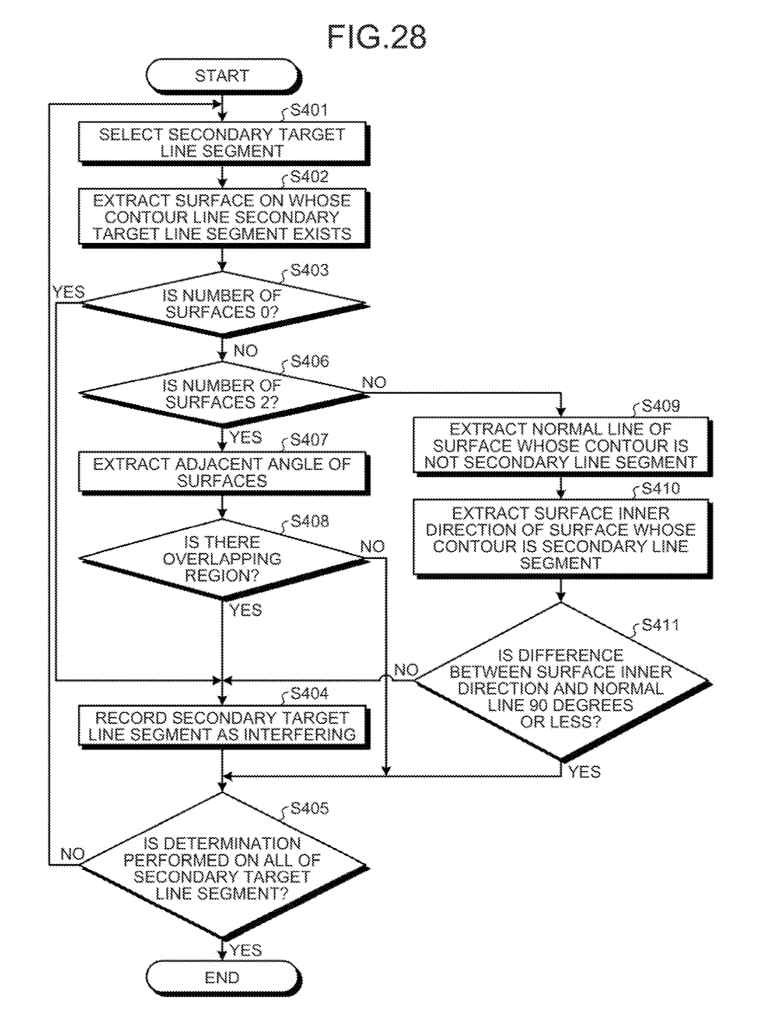

FIG. 28 is a flowchart illustrating the interference determination processing based on the secondary target line segment illustrated in FIG. 27. The inside/outside determination unit 42 that starts the interference determination processing based on the secondary target line segment selects a secondary target line segment (S401) and extracts a surface on whose contour line the secondary target line segment exists (S402). As a result of the extraction, in the case where the number of surfaces on whose contour lines the secondary target line segment exists is 0 (Yes in S403), the inside/outside determination unit 42 records the secondary target line segment as interfering in the recording unit 25 (S404).

In the case where the number of surfaces on whose contour lines the secondary line exists is not 0 (No in S403) but 2 (Yes in S406), the angle determination unit 43 extracts adjacent angles of both of the surfaces (S407). In the case where there is an overlapping region (Yes in S408), the secondary target line segment is recorded as interfering in the recording unit 25 (S404).

In the case where the number of surfaces on whose contours the secondary target line segment exists is not 2 (No in S406) but 1, the target determination unit 44 extracts a normal line of a surface whose contour is not the secondary target line segment (S409). The target determination unit 44 extracts a surface inner direction of the surface whose contour is the secondary target line segment (S410). When a difference between the surface inner direction and the normal line is not within 90 degrees (No in S411), the target determination unit 44 records the secondary target line segment as interfering in the recording unit 25 (S404).

After Step S404 or as a result of the determination by the target determination unit 44, in the case where the difference between the surface inner direction and the normal line is within 90 degrees (Yes in S411), and in the case where there is no overlapping region as a result of the determination by the angle determination unit 43 (No in S408), the inside/outside determination unit 42 determines whether or not the determination has been performed on all of the secondary target line segments (S405).

In the case where the secondary target line segment on which the determination is not performed remains (No in S405), the inside/outside determination unit 42 returns to Step S401. In the case where the determination is performed on all of the secondary line segments (Yes in S405), the inside/outside determination unit 42 brings the interference determination processing based on secondary target line segment to an end.

As described above, the interference determination device 2 disclosed in second embodiment performs the determination of possibility of interference by using three-dimensional bounding volumes and performs the interference determination on the combination of component parts having the possibility of interference after dividing the component parts into surfaces. Therefore, since it is unnecessary to arrange the bounding volumes in the tree form hierarchy structure to the edge shape in order to assimilate the bounding volumes to the polygon shape, it is possible to reduce the memory consumption for retaining the bounding volumes, thereby enabling suppression of memory consumption in the interference determination of a three-dimensional shape.

The number of models and the like are involved in the memory consumption and processing time, but, as one example, it is possible to reduce the total number of checks by 82.7% to 94.6%, thereby realizing a reduction of 84.2% of the memory consumption by OBB and a reduction of 13% to 43.1% of the processing time. Further, though the upper limit of usable memory in one application in the 32-bit OS is 1.5 to 2.0 GB, it is possible to use the interference check for the model to which the interference check has not been used due to the upper limit.

Further, the interference determination device 2 disclosed in second embodiment is capable of easily obtaining a surface by using a plurality of polygons having normal lines in one direction as one surface. Further, the interference determination device 2 disclosed in second embodiment realizes higher processing efficiency owing to creation of OBS which is a surface-like bounding volume enclosing the surfaces obtained by division and performing the determination of an interference state based on a relationship between an intersection line and a contour of OBS.

Since the interference determination device 2 disclosed in second embodiment performs the determination of interference state by creating information for identifying whether a contour of a surface is an outer rim of the surface or an inner rim of the surface, the interference determination device 2 enables determination with high accuracy without hierarchization of the bounding volumes even of a component part having a hole, thereby reducing memory consumption for retaining bounding volumes.

The interference determination device 2 disclosed in second embodiment is capable of determining interference even when two component parts are in contact by contours since the interference determination device 2 performs the determination of interference state by using an angle of a contour of a surface formed with another surface of an identical component part sharing the contour.

The interference determination device 2 disclosed in second embodiment is capable of determining interference with well balanced accuracy, speed, and memory consumption since the interference determination device 2 divides the surface into a plurality of surfaces in the case where the number of contour lines of the surface obtained by division is larger than the predetermined number.

The interference determination device 2 disclosed in second embodiment performs the determination of interference state based on a surface in the case where a contour line of another component part contacts at an inside of a surface of one component part, thereby making it possible to perform the interference determination even when the contour of another component part contacts with an inner part of the surface.

It is possible to obtain an interference determination program for causing a computer device to operate as an interference determination device by causing a CPU to execute the processing disclosed in second embodiment and storing the information disclosed in second embodiment in an arbitrary recording medium such as a memory. The computer may be an arbitrary device such as a mobile phone terminal insofar as the computer has an arithmetic device and a memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An interference determination device, comprising:
a polygon data input unit that inputs information of a first component part and a second component part each represented by a three-dimensional polygon model;
a dividing unit that divides the first component part into surfaces forming a periphery of the first component part and divides the second component part into surfaces forming a periphery of the second component part;
a surface information creation unit that creates information at least of a contour of each of the surfaces obtained by the division by the dividing unit as information relating to the surface; and
a surface interference determination unit that determines an interference state between the first component part and the second component part by comparing the contour of the surface obtained from the first component part with the contour of the surface obtained from the second component part.

2. The interference determination device according to claim 1, further comprising a bounding volume interference determination unit that performs an interference determination by comparing a bounding volume of the first component part and a bounding volume of the second component part, wherein the surface interference determination unit determines the interference state when there is a possibility of interference based on a result of the interference determination performed by the bounding volume interference determination unit.

3. The interference determination device according to claim 1, wherein the dividing unit recognizes a plurality of polygons of which normal lines are in an identical direction as one surface.

4. The interference determination device according to claim 1, wherein the surface information creation unit creates a surface-like bounding volume enclosing the surfaces obtained by the dividing unit and detects an intersection line between the surface obtained from the first component part and the surface obtained from the second component part with the use of the surface-like bounding volumes, and the surface interference determination unit determines the interference state based on a relationship between the intersection line and the contours.

5. The interference determination device according to claim 1, wherein the surface information creation unit creates information for distinguishing whether the contour of the surface is an outer rim or an inner rim of the surface; and the surface interference determination unit determines the interference state by using the information about whether the contour is the outer rim or the inner rim.

6. The interference determination device according to claim 1, wherein the surface information creation unit further creates information indicating an angle formed by the contour of the surface and another surface of the identical component part sharing the contour, and the surface interference determination unit determines the interference state by using the information indicating the angle.

7. The interference determination device according to claim 1, wherein, when a number of contour lines of the surface obtained by the division is larger than a predetermined number, the dividing unit divides the surface into a plurality of surfaces.

8. The interference determination device according to claim 1, wherein the surface interference determination unit determines the interference state based on a normal line of the surface obtained from the first component part when the contour line of the surface obtained from the second component part contacts at an inside of the contour line of the surface obtained from the first component part.

9. A method for determining interference comprising:
inputting information of a first component part and a second component part each represented by a three-dimensional polygon model;
dividing the first component part into surfaces forming a periphery of the first component part;
dividing the second component part into surfaces forming a periphery of the second component part;
creating information at least of a contour of each of the surfaces obtained by the division by the dividing as information relating to the surface; and
determining an interference state between the first component part and the second component part by comparing the contour of the surface obtained from the first component part and the contour of the surface obtained from the second component part.

10. A computer-readable recording medium that stores therein a computer program causing a computer to execute:
inputting information of a first component part and a second component part each represented by a three-dimensional polygon model;
dividing the first component part into surfaces forming a periphery of the first component part;
dividing the second component part into surfaces forming a periphery of the second component part;
creating information at least of a contour of each of the surfaces obtained by the division by the dividing as information relating to the surface; and
determining an interference state between the first component part and the second component part by comparing the contour of the surface obtained from the first component part and the contour of the surface obtained from the second component part.
